(19) United States
(12) Patent Application Publication
(10) Pub. No.: US 2019/0104368 A1
(43) Pub. Date: Apr. 4, 2019

(54) Multi-Purpose Tweeter Yoke

(71) Applicant: Google LLC, Mountain View, CA (US)

(72) Inventors: Michael Asfaw, Mountain View, CA (US); Michael Smedegaard, Danville, CA (US)

(21) Appl. No.: 15/819,148

(22) Filed: Nov. 21, 2017

Related U.S. Application Data
(60) Provisional application No. 62/566,917, filed on Oct. 2, 2017.

(51) Int. Cl. H04R 9/02

(52) U.S. Cl. CPC H04R 9/022

(57) ABSTRACT

The present disclosure provides a multi-purpose tweeter yoke. In particular, the yoke can comprise a continuous body. The body can serve as a magnetic flux director and can be shaped to increase surface area such that the yoke serves as a heat sink. In some embodiments, the body can comprise one or more fins that contribute at least in part to the heat sink. The fin(s) can be cylindrically shaped. In some embodiments, the fin(s) can include multiple cylindrically shaped fins that are concentric and define at least one cavity that provides at least a portion of the surface area.

### PRIORITY CLAIM

This application claims priority to U.S. Patent Application Ser. No. 62/566,917, filed Oct. 2, 2017, and entitled “MULTI-PURPOSE TWEETER YOKE,” the disclosure of which is incorporated by reference herein in its entirety.

### FIELD

The present disclosure relates generally to loudspeakers. More particularly, the present disclosure relates to a multi-purpose tweeter yoke.

### BACKGROUND

Tweeters are a type of loudspeaker designed to produce high audio frequencies (e.g., 2,000 to 20,000 hertz). A limitation of tweeters is their limited power handling due to overheating, which can cause the voice coil to burn up and/or the suspension to fall apart due to thermal cycling. To address this issue, some tweeters are outfitted with an aluminum or copper heatsink that is glued onto the speaker yoke. A disadvantage of this approach is that it creates an interface with low thermal conductivity and is associated with reliability issues (e.g., the heatsink can separate from the yoke when the unit is dropped, or the like).

### SUMMARY

Aspects and advantages of embodiments of the present disclosure will be set forth in part in the following description, or can be learned from the description, or can be learned through practice of the embodiments.

One example aspect of the present disclosure is directed to a tweeter yoke comprising a continuous body. The body can serve as a magnetic flux director and can be shaped to increase surface area such that the yoke serves as a heat sink. In some embodiments, the body can comprise one or more fins that contribute at least in part to the heat sink. The fin(s) can comprise one or more cylindrically shaped fins. Additionally or alternatively, the fin(s) can comprise one or more other geometrically shaped fins. In some embodiments, the fin(s) can comprise multiple cylindrically shaped fins that are concentric and define at least one cavity that provides at least a portion of the surface area. In some embodiments, the body can comprise a common (or the same) material that serves as the magnetic flux director and the heat sink. The common material can comprise low-carbon steel. In some embodiments, the body can be distinct from a pole plate of a transducer for which the yoke is configured.

Another example aspect of the present disclosure is directed to a tweeter comprising a transducer including a yoke that serves as a heat sink. In some embodiments, the yoke can comprise one or more fins that contribute at least in part to the heat sink. The fin(s) can comprise one or more cylindrically shaped fins. In some embodiments, the fin(s) can comprise multiple cylindrically shaped fins that are concentric and define at least one cavity that provides exposed surface area that contributes at least in part to the heat sink. In some embodiments, the yoke can comprise a common (or the same) material that serves as the heat sink and as a magnetic flux director of the transducer. The common material can comprise low-carbon steel. In some embodiments, the transducer can comprise a pole plate distinct from the yoke.

Another example aspect of the present disclosure is directed to a tweeter yoke comprising multiple cylindrically shaped fins. In some embodiments, the fins can contribute at least in part to a heat sink. In some embodiments, the fins are concentric and define at least one cavity that provides exposed surface area that contributes at least in part to the heat sink. In some embodiments, the yoke can comprise a common (or the same) material that serves as a magnetic flux director and a heat sink. The common material can comprise low-carbon steel. In some embodiments, the yoke can be distinct from a pole plate of a transducer for which the yoke is configured.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIGS. 1A and 1B depict cross-section isometric views of an example tweeter assembly according to example embodiments of the present disclosure;

FIGS. 2A and 2B depict top views of an example tweeter yoke according to example embodiments of the present disclosure;

FIGS. 3A and 3B depict bottom views of an example tweeter yoke according to example embodiments of the present disclosure;

FIG. 4 depicts example dimensions of an example tweeter yoke according to example embodiments of the present disclosure; and

FIG. 5 depicts example performance results of an example tweeter according to example embodiments of the present disclosure.

### DETAILED DESCRIPTION

Generally, the present disclosure is directed to a multi-purpose tweeter yoke. In particular, the yoke can comprise a continuous body that serves as a magnetic flux director of a transducer for which the yoke is configured, and the body can also function as a heat sink. The body can be shaped to increase exposed surface area that contributes at least in part to the heat sink. In some embodiments, the body can comprise one or more fins that contribute at least in part to the heat sink. The fin(s) can comprise one or more cylindrically shaped fins. In some embodiments, the fin(s) can comprise multiple cylindrically shaped fins that are concentric and define at least one cavity that provides at least a portion of the surface area. The body can comprise a common (or the same) material that serves as the magnetic flux director and the heat sink. In some embodiments, the common material can comprise low-carbon steel. In some embodiments, the body can be distinct from a pole plate of the transducer.

The tweeter yoke described herein can provide a number of technical effects and benefits. For example, the yoke (e.g., the exposed surface area) can enable heat dissipation through convection, thereby increasing the power handling capabilities of a tweeter for which the yoke is configured. Additionally or alternatively, the resilient design of the yoke can increase the durability of a tweeter for which it is configured, allowing the tweeter to withstand external forces (e.g., if it is dropped, or the like).

With reference now to the Figures, example embodiments of the present disclosure will be discussed in further detail.

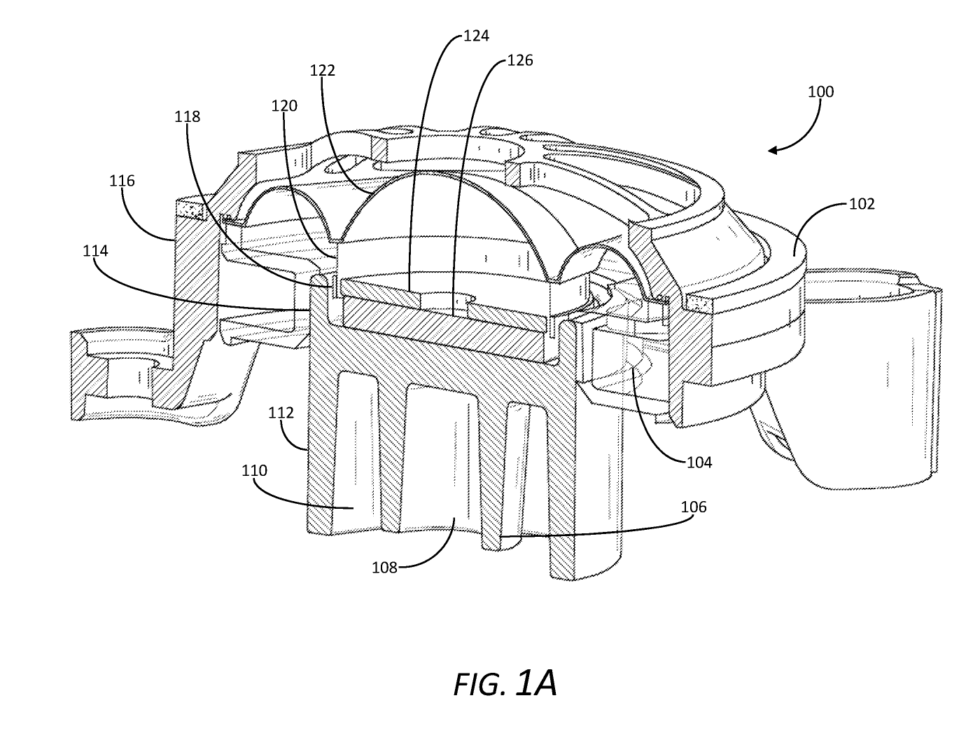

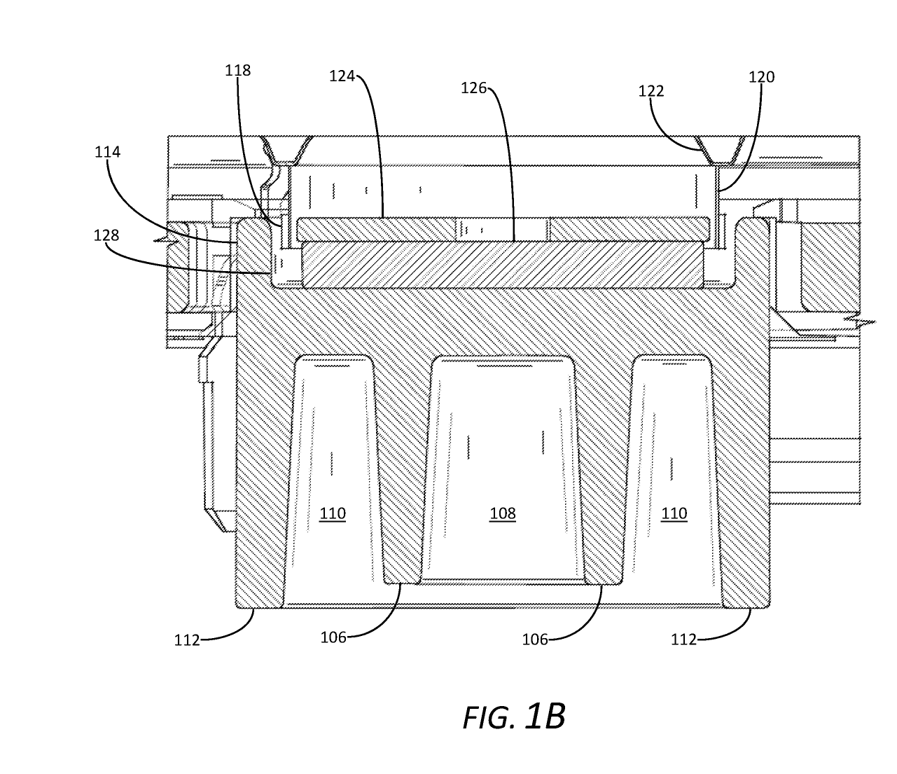

FIGS. 1A and 1B depict cross-section isometric views of an example tweeter assembly according to example embodiments of the present disclosure. Referring to FIG. 1A, assembly 100 can include frame 116 (e.g., a plastic frame) for housing a tweeter. Assembly 100 can include gasket 102 (e.g., a foam gasket) for interfacing frame 116 with an enclosure (e.g., of a device that comprises the tweeter). Assembly 100 can also include back volume chamber 104 and a transducer.

The transducer can include surround (or diaphragm) 122, former 120, and voice coil 118. Former 120 can interface surround 122 with voice coil 118. The transducer can also include pole plate 124, magnet 126, and yoke 114. As illustrated, pole plate 124, magnet 126, and yoke 114 can be distinct bodies. When an electrical signal is applied to voice coil 118, a magnetic field can be created by the electric current in voice coil 118, making it a variable electromagnet, which can interact with the field of magnet 126 to generate mechanical force that causes voice coil 118 and thus surround 122 (e.g., via former 120) to move and produce high audio frequencies (e.g., 2,000 to 20,000 hertz) under the control of the applied electrical signal.

Yoke 114 can comprise a continuous body that serves as a magnetic flux director of the transducer. In accordance with aspects of the disclosure, the body of yoke 114 can be shaped to increase exposed surface area such that yoke 114 serves as a heat sink (e.g., enables heat dissipation through convection). For example, yoke 114 can comprise fins 112 and 106. As illustrated, fins 112 and 106 can be cylindrically shaped, can be concentric, and can define cavities 110 and 108. Cavities 110 and 108 can provide at least a portion of the exposed surface area that contributes at least in part to the heat sink.

The body of yoke 114 can comprise a common (or the same) material that serves as the magnetic flux director for the transducer and as the heat sink. In some embodiments, the common material can comprise low-carbon steel.

Referring to FIG. 1B, the arrangement of yoke 114, voice coil 118, pole plate 124, magnet 126, surround 122, and former 120 can be seen in more detail. Fins 112 and 106 and cavities 110 and 108 are also illustrated. Additionally, cutout 128 is illustrated. Yoke 114 can include cutout 128, which can provide a surface at which yoke 114 and magnet 126 interface.

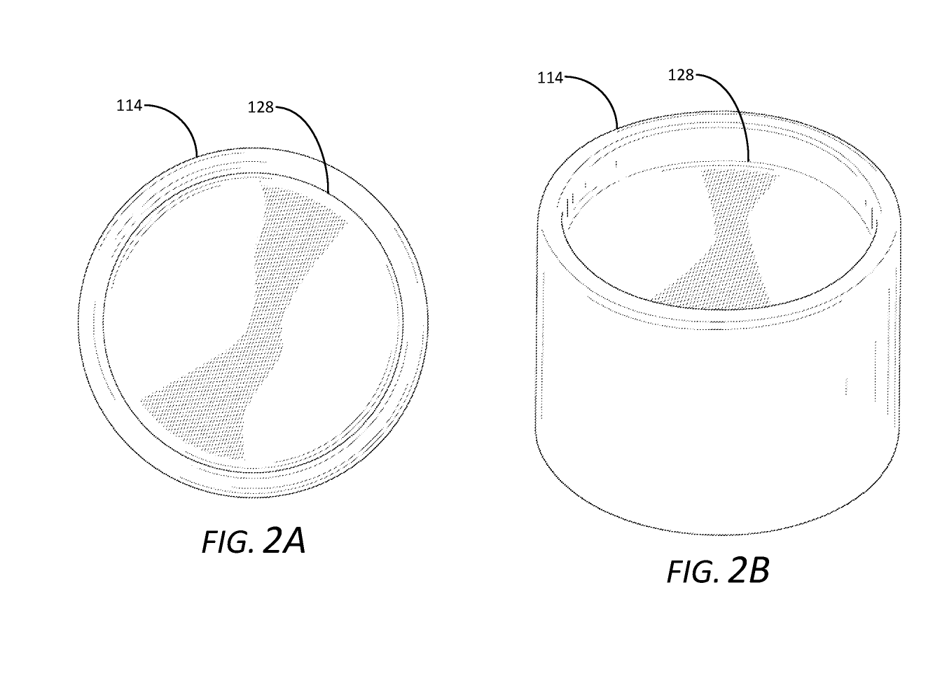

FIGS. 2A and 2B depict top views of an example tweeter yoke according to example embodiments of the present disclosure. Referring to FIGS. 2A and 2B, cutout 128 is illustrated.

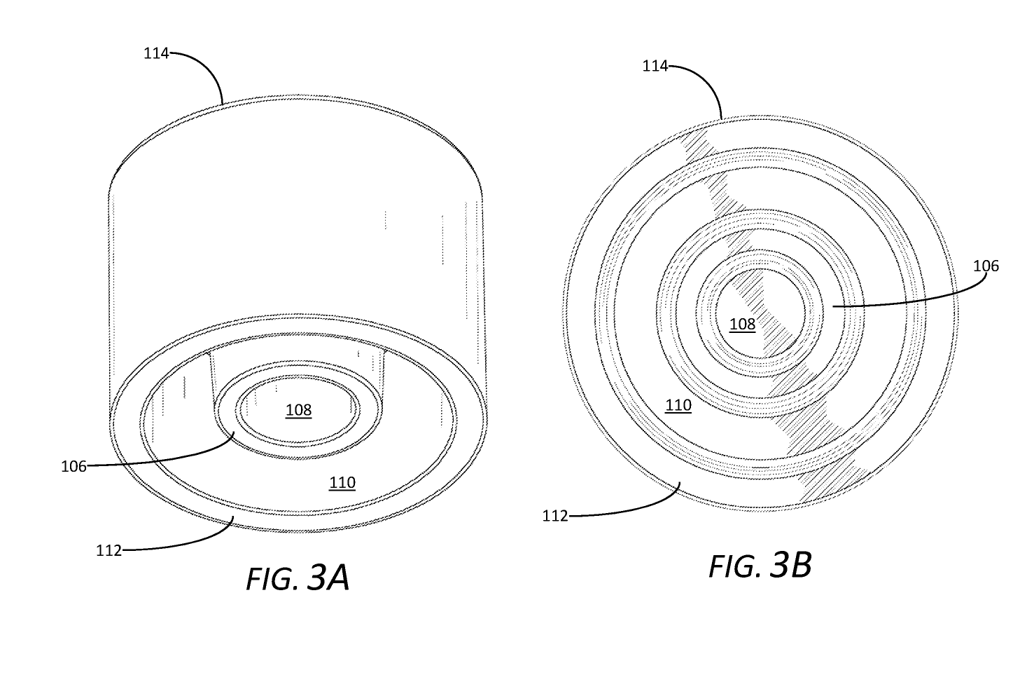

FIGS. 3A and 3B depict bottom views of an example tweeter yoke according to example embodiments of the present disclosure. Referring to FIGS. 3A and 3B, fins 112 and 106 and cavities 110 and 108 are illustrated.

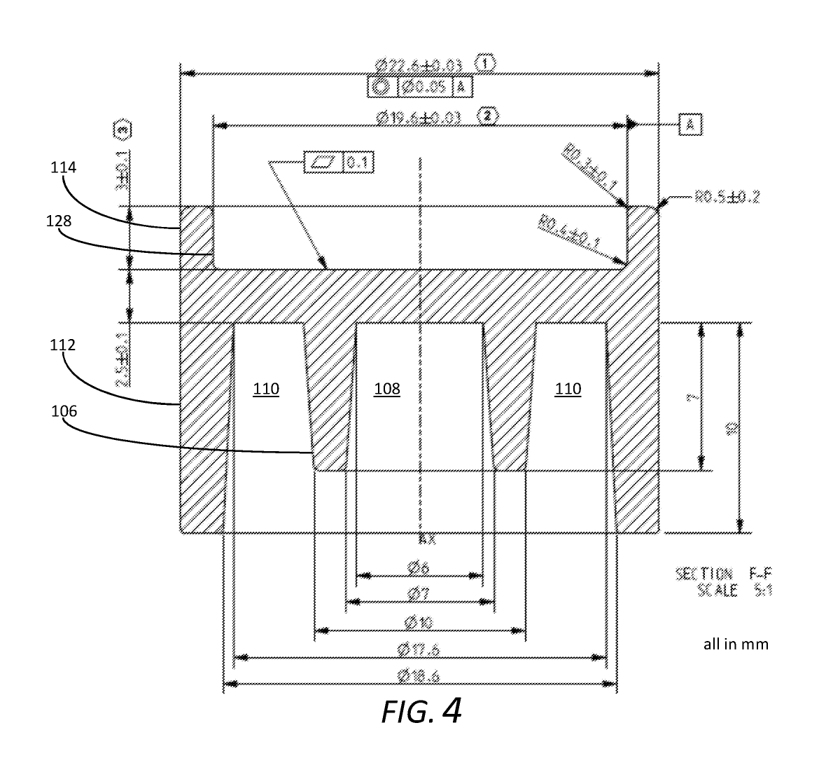

FIG. 4 depicts example dimensions of an example tweeter yoke according to example embodiments of the present disclosure. Referring to FIG. 4, fins 112 and 106, cavities 110 and 108, and cutout 128 are illustrated. All illustrated dimensions are in millimeters (mm).

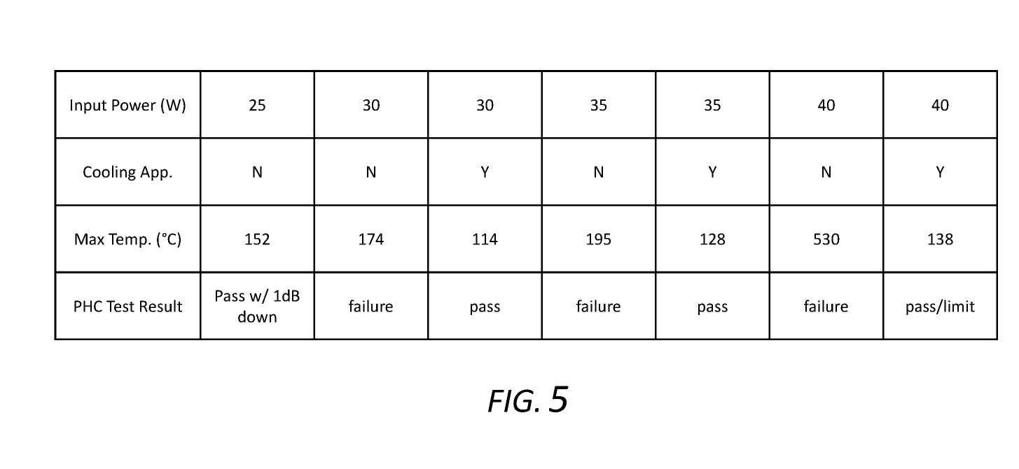

FIG. 5 depicts example performance results of an example tweeter according to example embodiments of the present disclosure. For example, the results indicate that at 35 watts, without implementing the cooling application described herein (e.g., without utilizing a yoke in accordance with embodiments of the present disclosure), a maximum temperature of 195 degrees centigrade was recorded, and the power handling capability test failed. The results also indicate that at 35 watts, implementing the cooling application described herein (e.g., utilizing a yoke in accordance with embodiments of the present disclosure), a maximum temperature of 128 degrees centigrade was recorded, and the power handling capability test passed.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. A tweeter yoke comprising a continuous body that serves as a magnetic flux director and is shaped to increase surface area such that the yoke serves as a heat sink.

2. The tweeter yoke of claim 1, wherein the continuous body comprises one or more fins that contribute at least in part to the heat sink.

3. The tweeter yoke of claim 2, wherein the one or more fins comprise one or more cylindrically shaped fins.

4. The tweeter yoke of claim 3, wherein the one or more cylindrically shaped fins comprise multiple cylindrically shaped fins that are concentric and define at least one cavity that provides at least a portion of the surface area.

5. The tweeter yoke of claim 1, wherein the continuous body comprises a common material that serves as the magnetic flux director and the heat sink.

6. The tweeter yoke of claim 5, wherein the common material comprises low-carbon steel.

7. The tweeter yoke of claim 1, wherein the continuous body is distinct from a pole plate of a transducer for which the yoke is configured.

8. A tweeter comprising a transducer including a yoke that serves as a heat sink.

9. The tweeter of claim 8, wherein the yoke comprises one or more fins that contribute at least in part to the heat sink.

10. The tweeter of claim 9, wherein the one or more fins comprise one or more cylindrically shaped fins.

11. The tweeter of claim 10, wherein the one or more cylindrically shaped fins comprise multiple cylindrically shaped fins that are concentric and define at least one cavity that provides exposed surface area that contributes at least in part to the heat sink.

12. The tweeter of claim 8, wherein the yoke comprises a common material that serves as the heat sink and as a magnetic flux director of the transducer.

13. The tweeter of claim 12, wherein the common material comprises low-carbon steel.

14. The tweeter of claim 8, wherein the transducer comprises a pole plate distinct from the yoke.

15. A tweeter yoke comprising multiple cylindrically shaped fins.

16. The tweeter yoke of claim 15, wherein the multiple cylindrically shaped fins contribute at least in part to a heat sink.

17. The tweeter yoke of claim 16, wherein the multiple cylindrically shaped fins are concentric and define at least one cavity that provides exposed surface area that contributes at least in part to the heat sink.

18. The tweeter yoke of claim 15, wherein the yoke comprises a common material that serves as a magnetic flux director and a heat sink.

19. The tweeter yoke of claim 18, wherein the common material comprises low-carbon steel.

20. The tweeter yoke of claim 15, wherein the yoke is distinct from a pole plate of a transducer for which the yoke is configured.
